(19) United States
(12) Patent Application Publication
(10) Pub. No.: US 2025/0267540 A1
(43) Pub. Date: Aug. 21, 2025

(54) ELECTRONIC APPARATUS, METHOD FOR CONTROLLING THE SAME, AND COMPUTER-READABLE STORAGE MEDIUM STORING A PROGRAM

(71) Applicant: CANON KABUSHIKI KAISHA, Tokyo (JP)

(72) Inventor: SHINICHI ICHIMURA, Kanagawa (JP)

(21) Appl. No.: 19/054,175

(22) Filed: Feb. 14, 2025

(30) Foreign Application Priority Data
Feb. 20, 2024 (JP) 2024-023948

(51) Int. Cl. H04W 36/08; H04W 36/30

(52) U.S. Cl. CPC H04W 36/08; H04W 36/304

(57) ABSTRACT

An electronic apparatus includes a communication device unit that receives, from a first access point to which the electronic apparatus is currently connected, a change request of an access point serving as a connection destination and at least one memory storing a program and at least one processor that when executing the program stores, after receipt of the change request, information regarding a second access point that is a connection change destination recommended in the change request, performs control to not change the connection destination based on the received change request, and performs control, when the electronic apparatus is disconnected from the currently connected first access point, to connect to the second access point based on the stored information.

### BACKGROUND

### Field

The present disclosure relates to an electronic apparatus that changes an access point (AP) serving as a connection destination based on a change request of a connection destination from the AP, a method for controlling the same, and a computer-readable storage medium storing a program.

### Description of the Related Art

Japanese Patent Laid-Open No. 2021-175068 discusses processing in which a router with AP functionality requests a wireless client apparatus connected to it to change its connection destination. A mobile router (MR1) that can connect to a plurality of wireless client apparatuses checks whether a wireless client terminal is compliant with IEEE 802.11v. Whether a wireless client terminal is compliant with IEEE 802.11v can be determined based on an Association Request frame that the wireless client terminal transmits when wirelessly connecting to the MR1. If the wireless client terminal is IEEE 802.11v compliant, a BSS transition management (BTM) Request frame is transmitted to the wireless client terminal. In the BSS Transition Candidate List Entries field of the BTM Request frame, the BSSID of a parent router RT2 is specified as the connection destination. This prompts the client terminal to change its connection destination, and the wireless client terminal changes its connection destination from the MR1 to the RT2 in accordance with the received BTM Request frame.

In an extended service set (ESS) including a plurality of access points (APs), there is a technique for dynamically changing the AP serving as a connection destination to efficiently exchange data between the AP and a station (STA). When it is determined that the AP serving as the connection destination should be changed based on factors such as the congestion of the AP to which the STA is connected, the availability of the other APs, and radio wave conditions, the currently connected AP transmits a connection destination AP change request to the STA. When receiving an AP change request, the STA can connect to an appropriate AP by changing the connection destination AP in based on the request.

An STA may be in a state where no problem occurs after switching APs, or in a state where a problem occurs due to switching APs or losing communication with an AP. If an STA receives an AP change request from an AP in the state where a problem occurs and changes the connection destination AP in response to the request, the STA may experience a problem. To avoid a problem, the STA may perform control to not change the connection destination AP, but after this control, the STA may be disconnected from the AP to which it was connected. In such a case, the STA may be in a state where it is not connected to the network. Therefore, there is need to appropriately perform control to reconnect to the network when an electronic apparatus operating as an STA loses its connection to an AP.

### SUMMARY

The present disclosure provides an electronic apparatus that performs control to reconnect to a network when the electronic apparatus is disconnected from an AP, a method for controlling the same, and a computer-readable storage medium storing a program.

According to one aspect of the present disclosure, an electronic apparatus comprises a communication device unit configured to receive, from a first access point to which the electronic apparatus is currently connected, a change request of an access point serving as a connection destination, and at least one memory storing a program and at least one processor that when executing the program is configured to store, after receipt of the change request, information regarding a second access point that is a connection change destination recommended in the change request, perform control to not change the connection destination based on the received change request, and perform control, when the electronic apparatus is disconnected from the currently connected first access point, to connect to the second access point based on the stored information.

According to this aspect of the present disclosure, it is possible to perform control to reconnect to a network when the electronic apparatus is disconnected from an AP.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration.

FIGS. 2A and 2B are diagrams illustrating examples of the configuration of a multi-function peripheral (MFP).

FIGS. 3A to 3C are diagrams illustrating examples of displays on an operation display unit of the MFP.

FIGS. 4A and 4B are diagrams illustrating the configuration of a mobile terminal apparatus.

FIG. 5 is a diagram illustrating the configuration of an access point (AP).

FIG. 6 is a diagram illustrating processing performed in response to a connection destination change request from an AP.

FIGS. 7A and 7B are flowcharts illustrating processing performed in response to a connection destination change request from an AP.

### DESCRIPTION OF THE EMBODIMENTS

Hereinafter, embodiments will be described in detail with reference to the attached drawings. The following embodiments are not intended to limit the scope of the present disclosure. Multiple features are described in the embodiments, but all features are not required and multiple features may be combined as appropriate. In the attached drawings, the same reference numerals are provided to the same or similar configurations, and redundant description thereof is omitted.

### System Configuration

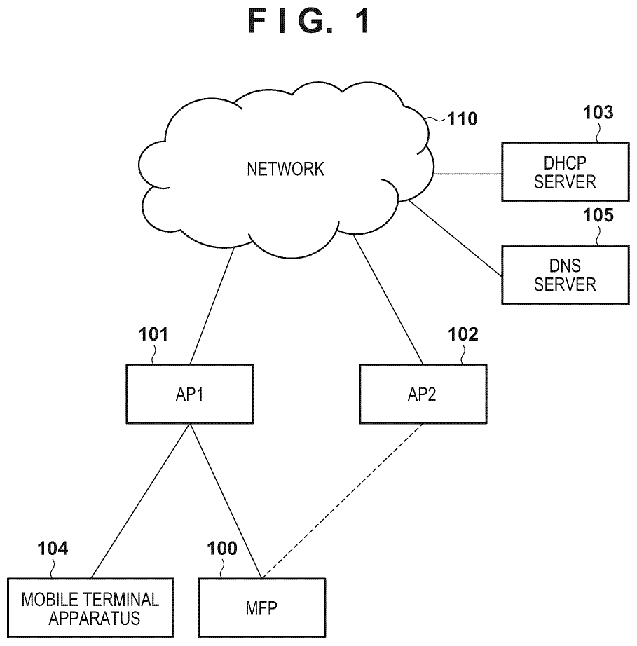

FIG. 1 illustrates an example of the configuration of a system according to the present embodiment. In the example, the system is a wireless communication system in which a plurality of communication apparatuses can wirelessly communicate with each other. FIG. 1 includes, as communication apparatuses, a mobile terminal apparatus 104, an MFP 100, APs 101 and 102, a DHCP server 103, a DNS server 105, and a network 110. The AP 101 and the AP 102 may be illustrated as “AP1” and “AP2”. The mobile terminal apparatus 104 is an apparatus having a wireless communication function using a wireless LAN or the like. Hereinafter, a wireless LAN may be referred to as a “WLAN”. The mobile terminal apparatus 104 may be a personal information terminal such as a personal digital assistant (PDA), a mobile phone (smartphone), a digital camera, a personal computer, or the like.

The MFP 100 is a printing apparatus having a printing function, and may also have a reading function (scanner), a FAX function, and a telephone function. The MFP 100 according to the present embodiment also has a communication function that wirelessly communicates with the mobile terminal apparatus 104. While the present embodiment describes an example in which the MFP 100 is used, the present disclosure is not limited to this example. For example, a scanner apparatus, a projector, a mobile terminal, a smartphone, a laptop PC, a tablet terminal, a PDA, a digital camera, a music playback device, a television, a smart speaker, or the like, each having a communication function, may be used in place of the MFP 100.

The AP 101 is provided separately (externally) from the mobile terminal apparatus 104 and the MFP 100 and operates as a base station apparatus for the WLAN. A communication apparatus having a WLAN communication function can perform communication in the WLAN infrastructure mode via the AP 101. Hereinafter, the access points may be referred to as “APs”. The infrastructure mode may be referred to as a “wireless infrastructure mode”. The AP 101 performs wireless communication with a communication apparatus that has been authorized to connect to the AP 101 (a communication apparatus that has been authenticated), and relays wireless communication between the communication apparatus and another communication apparatus. In addition, the AP 101 may be connected to, for example, a wired communication network, and relay communication between a communication apparatus connected to the wired communication network and another communication apparatus wirelessly connected to the AP 101.

The AP 102 has the same functions as the AP 101. The MFP 100 changes the connection destination from the AP 101 to the AP 102 as necessary. The DHCP server 103 connects to the MFP 100 via the AP 101 and the network 110, and provides services to the MFP 100 by responding to requests from the MFP 100. While FIG. 1 illustrates a configuration in which the DHCP server 103 is connected as a separate apparatus from the APs 101 and 102, the APs 101 and 102 may each have a DHCP server function. The DNS server 105 is connected to the MFP 100 and the mobile terminal apparatus 104 via the AP 101 and the network 110, and provides a name resolution service by responding to requests from the MFP 100 and the mobile terminal apparatus 104. The network 110 may be the so-called Internet, or may be a closed network within a company or a mobile phone network.

### External Configuration of MFP

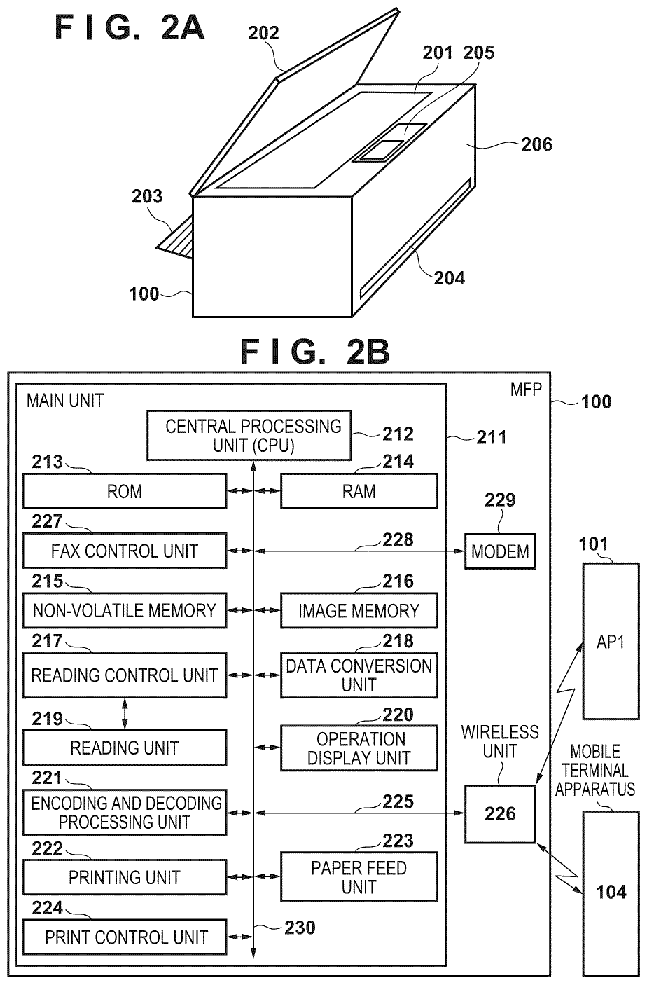

FIG. 2A illustrates an example of the external configuration of the MFP 100. The MFP 100 includes, for example, a document table 201, a document cover 202, a print paper insertion slot 203, a print paper ejection slot 204, and an operation display unit 205. The document table 201 is a table on which the document to be read is placed. The document cover 202 is a cover for holding down the document placed on the document table 201 and preventing light from a light source irradiating the document during reading from leaking out from the MFP 100. The print paper insertion slot 203 is an insertion slot into which paper of various sizes can be set. The print paper ejection slot 204 is an ejection slot through which printed paper is ejected. The paper sheets set in the print paper insertion slot 203 are transported one-by-one to a printing unit, where printing is carried out, and then ejected from the print paper ejection slot 204. The operation display unit 205 includes keys such as character input keys, cursor keys, an enter key, and a cancel key, as well as an LED and an LCD, and is configured to accept user operations for activating various MFP functions and making various settings. The operation display unit 205 may also include a touch panel display.

The MFP 100 has a WLAN wireless communication function, and includes a wireless communication antenna 206 for such wireless communication, which need not be visible external to the MFP 100. The MFP 100 can perform wireless communication in the 2.4 GHz and 5 GHz frequency bands via the WLAN.

### Configuration of MFP

FIG. 2B illustrates an example of the configuration of the MFP 100. The MFP 100 includes a main unit 211 that performs control of the MFP 100, and a wireless unit 226 that is one communication module that performs WLAN communication using at least one common antenna. The MFP 100 also includes a modem 229 for performing, for example, wired communication. The main unit 211 is includes functional blocks other than the wireless unit 226 and the modem 229. The main unit 211 includes, for example, a central processing unit (CPU) 212, a Read Only Memory (ROM) 213, a Random Access Memory (RAM) 214, a non-volatile memory 215, an image memory 216, a reading control unit 217, a data conversion unit 218, a reading unit 219, and an encoding and decoding processing unit 221. The main unit 211 also includes, for example, a printing unit 222, a paper feed unit 223, a print control unit 224, and an operation display unit 220. These functional units included in the main unit 211 are connected to each other via a system bus 230 managed by the CPU 212. The main unit 211 and the wireless unit 226 are connected via, for example, a dedicated bus 225, and the main unit 211 and the modem 229 are connected via, for example, a bus 228.

The CPU 212 is a system control unit that includes at least one processor, and controls the MFP 100. In one example, the processing performed by the MFP 100 described below is realized by the CPU 212 executing a program stored in the ROM 213. Dedicated hardware elements may be provided for each kind of processing. The ROM 213 stores a control program to be executed by the CPU 212, an embedded OS program, etc. In the present embodiment, the CPU 212 executes each control program stored in the ROM 213 under the management of the embedded OS, also stored in the ROM 213, thereby performing software control such as scheduling and task switching.

The RAM 214 is constituted by an SRAM or the like. The RAM 214 stores data such as program control variables, setting values registered by the user, management data for the MFP 100, etc. The RAM 214 can also be used as a buffer for various kinds of work. The non-volatile memory 215 is constituted by a memory such as a flash memory, and continues to store data even when the MFP 100 is turned off. The image memory 216 is constituted by a memory such as a DRAM. The image memory 216 accumulates image data received via the wireless unit 226, image data processed by the encoding and decoding processing unit 221, etc. The memory configuration of the MFP 100 is not limited to the above-described configuration. The data conversion unit 218 analyzes data in various formats and converts image data into print data.

The reading control unit 217 controls the reading unit 219 (for example, a contact image sensor (CIS)) to optically read a document placed on the document table 201. The reading control unit 217 converts and outputs an image obtained by optically reading a document into electrical image data (image signals). At this time, the reading control unit 217 may output the image data after performing thereon various kinds of image processing such as binarization and halftoning.

The operation display unit 220 is the operation display unit 205 described with reference to FIG. 2A, and performs display on a display based on display control performed by the CPU 212, generation of signals in response to acceptance of a user operation, etc.

The encoding and decoding processing unit 221 performs encoding and decoding processing and enlargement and reduction processing on image data (JPEG, PNG, etc.) handled by the MFP 100.

The paper feed unit 223 stores paper for printing. The paper feed unit 223 can feed the set paper under the control of the print control unit 224. The paper feed unit 223 may include a plurality of paper feed units to store a plurality of types of paper in one apparatus, and can control which paper feed unit is to be used for paper feeding under the control of the print control unit 224.

The print control unit 224 performs various kinds of image processing such as smoothing, print density correction, and color correction on the image data to be printed, and outputs the processed image data to the printing unit 222. The printing unit 222 is configured to perform, for example, inkjet printing processing, and ejects ink supplied from ink tanks from print heads to record an image on a recording medium such as paper. The printing unit 222 may be configured to perform another kind of printing processing such as electrophotographic printing processing. The print control unit 224 can periodically read out information from the printing unit 222, and update, for example, status information stored in the RAM 214, including the remaining ink levels in the ink tanks, the state of the print heads, etc.

The wireless unit 226 provides a WLAN communication function, and provides, for example the same functions as a combination with the WLAN unit 401 of the mobile terminal apparatus 104. The wireless unit 226 converts data into packets in accordance with the WLAN standard and transmits the packets to another device. The wireless unit 226 also restores packets from another external device to the original data and outputs the restored data to the CPU 212. The wireless unit 226 communicates as a STA that conforms to the IEEE 802.11 standard series. In particular, the wireless unit 226 communicates as a STA that conforms to IEEE 802.11a/b/g/n/ac/ax. The wireless unit 226 also communicates as an STA compliant with Wi-Fi Agile Multiband™

The wireless unit 226 is compliant with IEEE 802.11ax, i.e., Wi-Fi6, and performs processing conforming to IEEE 802.11ax. The MFP 100 performs operations (processing) as an STA compliant with Orthogonal Frequency Division Multiple Access (OFDMA), operations (processing) as an STA compliant with Target Wake Time (TWT), or both. Since the wireless unit 226 is compliant with TWT, the timing of data communication from the parent apparatus to the STA is adjusted. The wireless unit 226 serving as an STA causes the communication function thereof to transition to a sleep state when it does not need to wait for signal reception. This enables reducing power consumption. The wireless unit 226 is also compliant with Wi-Fi 6E. Thus, communication in the 6 GHz band (5.925 GHz to 7.125 GHz) is also possible. The bands in the 5 GHz band that are subject to Dynamic Frequency Selection (DFS) are not present in the 6 GHz band. Therefore, when communicating in the 6 GHz band, communication interruptions due to DFS waiting times will not occur, and smoother communication can be expected.

The mobile terminal apparatus 104 and the MFP 100 perform peer-to-peer (P2P) (WLAN) communication based on W-Fi Direct® (WFD), and the wireless unit 226 has a software access point (Soft AP) function or a group owner function. The wireless unit 226 can build a network for P2P communication and determine the channel to be used for P2P communication.

### Operation Display Unit of MFP

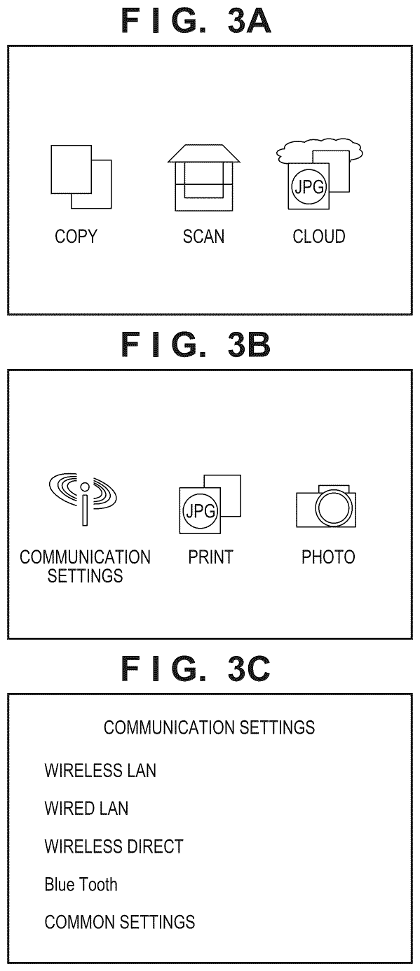

FIG. 3 illustrates an example of a screen display on a display (touch panel display) included in the operation display unit 220 of the MFP 100. FIG. 3A illustrates an example of a home screen that is displayed when the MFP 100 is turned on and no operation such as printing or scanning is being performed (idle state, standby state). In FIG. 3A, display items (menu items) corresponding to Copy, Scan, and Cloud are displayed. Cloud is a menu item related to a cloud function that uses Internet communication. When any of the menu items is selected by key operation or touch panel operation, the MFP 100 can start executing the setting or function corresponding thereto. The MFP 100 can seamlessly display a screen different from that illustrated in FIG. 3A by accepting key operation or touch panel operations on the home screen illustrated in FIG. 3A.

FIG. 3B illustrates a display example of another area of the home screen and is a screen that the screen illustrated in FIG. 3A transitions to in response to an operation (such as a sliding operation to the left or right) performed to display another page of the home screen. In FIG. 3B, display items (menu items) corresponding to Communication settings, Printing, and Photos are displayed. When any of these menu items is selected, the function corresponding to the selected menu item, i.e., the print function, photo function, or communication setting function, is executed.

FIG. 3C illustrates a display example of a menu screen for communication settings that is displayed when Communication Settings is selected on the screen in FIG. 3B. The communication settings menu screen displays “Wireless LAN”, “Wired LAN”, “Wireless Direct”, “Bluetooth”, and “Common Settings” as menu items (options). “Wireless LAN”, “Wired LAN”, and “Wireless Direct” are menu items for LAN settings, and settings for wired connections, settings to enable/disable the wireless infrastructure mode, and settings to enable/disable a P2P mode such as WFD or Soft AP mode can be made from these items. When the item “Wireless LAN” is selected and the wireless LAN is enabled by user operation, the wireless infrastructure mode is enabled. When the item “Wireless Direct” is selected and Wireless Direct is enabled by user operation, the P2P (WLAN) mode is enabled. This screen also displays a common setting menu for connection modes. A user can set, for example, the frequency band and the frequency channel of the wireless LAN from this screen.

### External Configuration of Mobile Terminal Apparatus

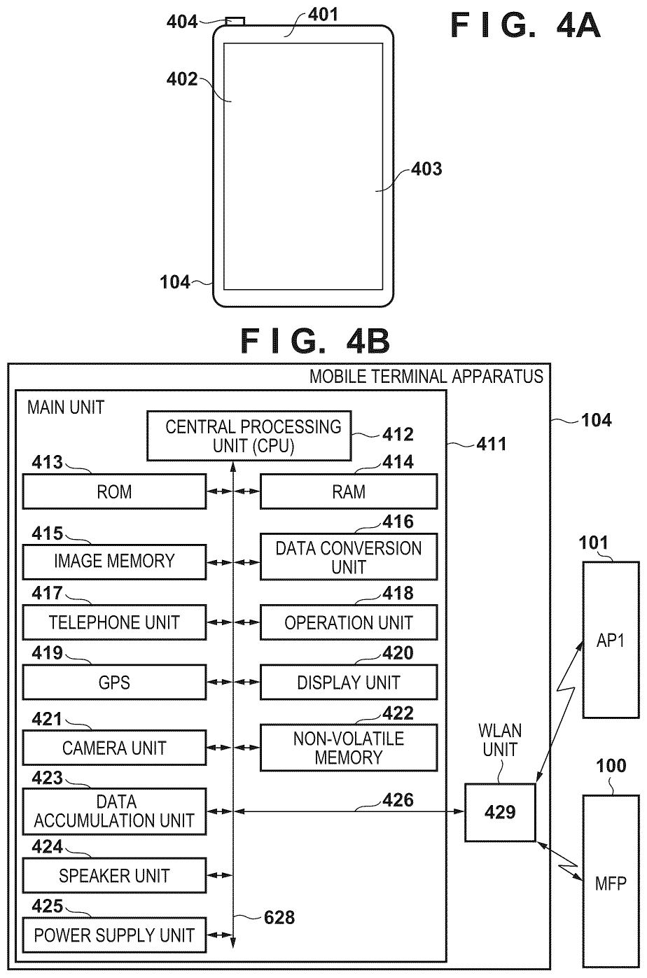

FIG. 4A is a diagram illustrating an example of the external configuration of the mobile terminal apparatus 104. In the present embodiment, as an example, the mobile terminal apparatus 104 is a smartphone. The mobile terminal apparatus 104 includes, for example, a display unit 402, an operation unit 403, and a power key 404. The display unit 402 is, for example, a display including a display mechanism of the liquid crystal display (LCD) type. The display unit 402 may display information using, for example, a light emitting diode (LED) or the like. The mobile terminal apparatus 104 may have a function of outputting information using audio in addition to or instead of the display unit 402. The operation unit 403 includes physical keys such as keys and buttons, a touch panel, etc., for detecting user operations. In the present example, a common touch panel display is used to display information on the display unit 402 and to receive user operations input with the operation unit 403. Thus, the display unit 402 and the operation unit 403 are realized using a single apparatus. In the present case, for example, button icons and a software keyboard are displayed using the display function of the display unit 402, and the operation reception function of the operation unit 403 detects that the user has touched these locations. The display unit 402 and the operation unit 403 may be separated, and hardware for displaying and hardware for accepting operations may be provided separately. The power key 404 is a hardware key for accepting a user operation for turning on or off the mobile terminal apparatus 104.

The mobile terminal apparatus 104 includes a WLAN unit 401 that provides a WLAN communication function, which need not be visible external to the mobile terminal apparatus 104. The WLAN unit 401 is configured to perform data (packet) communication in a WLAN system that conforms to, for example, the IEEE 802.11 standard series (IEEE 802.11a/b/g/n/ac/ax, etc.). The WLAN unit 401 also communicates as an AP compliant with Wi-Fi Agile Multiband™. The WLAN unit 401 is not limited to this configuration, and may communicate in a WLAN system that conforms to other standards. In the present example, it is assumed that the WLAN unit 401 communicates in both the 2.4 GHz and 5 GHz frequency bands. It is also assumed that the WLAN unit 401 performs communication based on WFD, communication in the Soft AP mode, communication in the wireless infrastructure mode, etc. Operation in these modes will be described below.

### External Configuration of Mobile Terminal Apparatus

FIG. 4B illustrates an example of the configuration of the mobile terminal apparatus 104. In an example, the mobile terminal apparatus 104 includes a main unit 411 that performs control of the mobile terminal apparatus 104, and a WLAN unit 429 that performs WLAN communication. The main unit 411 is a unit that includes functional blocks other than the WLAN unit 429. The main unit 411 includes, for example, a CPU 412, a ROM 413, a RAM 414, an image memory 415, a data conversion unit 416, a telephone unit 417, a Global Positioning System (GPS) 419, a camera unit 421, a non-volatile memory 422, a data accumulation unit 423, a speaker unit 424, and a power supply unit 425. The mobile terminal apparatus 104 also includes a display unit 420 and an operation unit 418. These functional units included in the main unit 411 are connected to each other via a system bus 628 managed by the CPU 412. In addition, the main unit 411 and the WLAN unit 429 (the above-mentioned WLAN unit 401) are connected, for example, via a dedicated bus 426.

The CPU 412 is a system control unit that includes at least one processor, and controls the mobile terminal apparatus 104. In an example, the processing performed by the mobile terminal apparatus 104 described below is realized by the CPU 412 executing a program stored in the ROM 413. Dedicated hardware elements may be provided for each kind of processing. The ROM 413 stores the control program executed by the CPU 412, an embedded operating system (OS) program, and the like. In the present embodiment, the CPU 412 executes each control program stored in the ROM 413 under the management of the embedded OS also stored in the ROM 413, thereby performing software control such as scheduling and task switching.

The RAM 414 is constituted by a static RAM (SRAM) or the like. The RAM 414 stores data such as program control variables, setting values registered by the user, management data for the mobile terminal apparatus 104, etc. The RAM 414 can also be used as a buffer for various types of work. The image memory 415 is constituted by a memory such as a dynamic RAM (DRAM). The image memory 415 temporarily stores image data received via the WLAN unit 429 and image data read from the data accumulation unit 423 for processing by the CPU 412. The non-volatile memory 422 is constituted by a memory such as a flash memory, and continues to store data even when the mobile terminal apparatus 104 is turned off. The memory configuration of the mobile terminal apparatus 104 is not limited to the above-described configuration. For example, the image memory 415 and the RAM 414 may be shared, or the data accumulation unit 423 may be used to back up data. While a DRAM is provided as an example of the image memory 415 in the present embodiment, another storage medium such as a hard disk or a non-volatile memory may also be used.

The data conversion unit 416 performs analysis of data in various formats, and data conversion such as color conversion and image conversion. The telephone unit 417 controls the telephone line and processes audio data input and output via the speaker unit 424, thereby realizing telephone communication. The GPS 419 receives radio waves transmitted from satellites and acquires location information such as the current latitude and longitude of the mobile terminal apparatus 104.

The camera unit 421 has the function of electronically recording and encoding an image input through a lens. Image data acquired by imaging by the camera unit 421 is stored in the data accumulation unit 423. The speaker unit 424 performs control to realize the function of inputting or outputting voice for the telephone function, and other functions such as an alarm notification function. The power supply unit 425 is, for example, a portable battery, and controls the power supply to the apparatus. Examples of power states include a low battery state in which the battery has no power remaining, a power off state in which the power key 404 is not selected, a running state in which the apparatus is running normally, and a power saving state in which the apparatus is running but in a power saving mode.

The display unit 420 is the display unit 402 described with reference to FIG. 4A, and displays various input operations, the operating condition and status of the MFP 100, etc., under the control of the CPU 412. The operation unit 418 is the operation unit 403 described with reference to FIG. 4A, and upon receiving a user operation, executes control such as generating an electrical signal corresponding to the operation and outputting it to the CPU 412.

The mobile terminal apparatus 104 performs wireless communication using the WLAN unit 429 to perform data communication with another device such as the MFP 100. The WLAN unit 429 converts data into packets and transmits the packets to another device. The WLAN unit 429 restores packets from another external device to the original data and outputs the restored data to the CPU 412. The WLAN unit 429 is a unit for realizing communication conforming to the WLAN standard. The WLAN unit 429 can operate in at least two communication modes concurrently, including a wireless infrastructure mode and a P2P (WLAN) mode. The frequency bands used in these communication modes may be limited by the capabilities and performance of the hardware.

### Configuration of Access Point

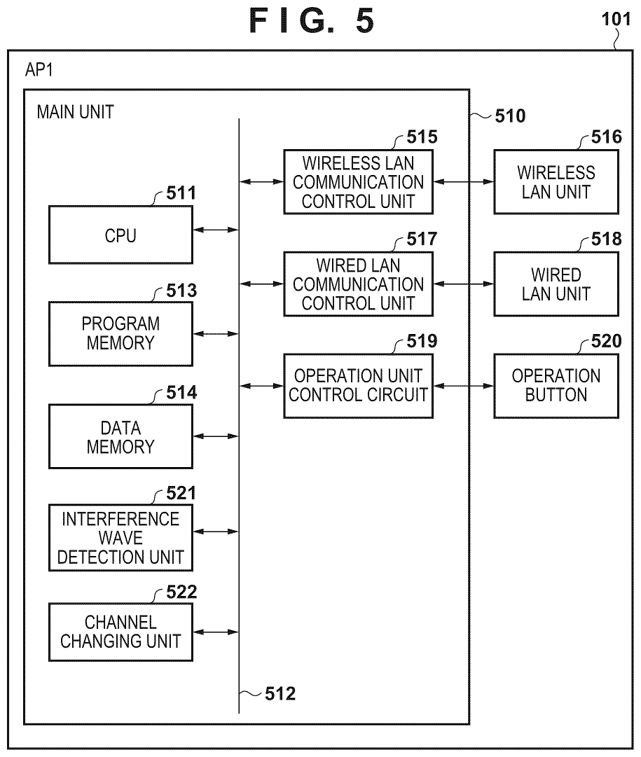

FIG. 5 is a block diagram illustrating the configuration of the AP 101 having a wireless LAN access point function. The AP 101 includes a main unit 510 that controls the AP 101, a wireless LAN unit 516, a wired LAN unit 518, and an operation button 520. The main unit 510 includes functional blocks other than the wireless LAN unit 516, the wired LAN unit 518, and the operation button 520.

A CPU 511 in the form of a microprocessor included in the main unit 510 operates according to a control program stored in a program memory 513 in the form of a ROM connected via an internal bus 512 and the content of a data memory 514 in the form of a RAM. The CPU 511 controls the wireless LAN unit 516 via a wireless LAN communication control unit 515 to perform wireless LAN communication with another communication terminal apparatus. The CPU 511 controls the wired LAN unit 518 via a wired LAN communication control unit 517 to perform wired LAN communication with another communication terminal apparatus. The CPU 511 controls an operation unit control circuit 519 to accept operations from the user via the operation button 520. The CPU 511 includes at least one processor.

The AP 101 includes an interference wave detection unit 521 and a channel change unit 522. The interference wave detection unit 521 performs interference wave detection processing while wireless communication is performed in a band in which dynamic frequency selection (DFS) is performed. When wireless communication is performed in a band in which DFS is performed, the channel change unit 522 performs processing to change the channel to be used if, for example, an interference wave is detected and it is necessary to immediately change the channel to an available channel.

The AP 102 has the same configuration as the AP 101.

### P2P Communication Method

Next, an overview of the P2P (WLAN) communication method will be described in which apparatuses communicate directly with each other wirelessly without using an external access point in WLAN communication. P2P (WLAN) communication can be realized using a plurality of techniques, and, for example, a communication apparatus can support a plurality of modes for P2P (WLAN) communication and selectively use one of the plurality of modes to perform P2P (WLAN) communication.

The following three modes are envisioned as P2P modes:
Soft AP Mode
Wi-Fi Direct® (WFD) Mode
Network Setup Mode
   A communication apparatus performing P2P communication may be configured to support at least one of these modes. A communication apparatus performing P2P communication does not necessarily have to support all of these modes and may be configured to support only some of the modes.

A communication apparatus (for example, the mobile terminal apparatus 104) having a WFD communication function accepts a user operation via its operation unit to call an application for realizing the communication function. The communication apparatus can then display a screen of a user interface (UI) provided by the application to prompt a user to perform an operation, and can execute WFD communication based on the user operation accepted in response to the display.

### Soft AP Mode

In the Soft AP mode, a communication apparatus (for example, the mobile terminal apparatus 104) operates as a client that requests various services. Another communication apparatus (for example, the MFP 100) operates as a Soft AP that can perform the WLAN AP functions by software settings. The commands and parameters transmitted and received when establishing a wireless connection between the client and the Soft AP need only be those specified in the Wi-Fi® standard, and the description thereof is omitted here. The MFP 100 operating in the Soft AP mode determines the frequency band and the frequency channel as the parent STA. Thus, the MFP 100 can select which frequency band to use, from 5 GHz and 2.4 GHz, and which frequency channel to use within that frequency band.

### WFD Mode

The MFP 100 may be configured to start up as a fixed parent STA in the WFD mode (Autonomous Group Owner). In the present case, Group Owner (GO) negotiation processing, which is performed to determine the role, is not required. In the present case, the MFP 100 determines the frequency band and the frequency channel as the parent STA. Thus, the MFP 100 can select which frequency band to use, from 5 GHz and 2.4 GHz, and which frequency channel to use within that frequency band.

### Network Setup Mode

The MFP 100 can operate in the network setup mode. The trigger for the MFP 100 to start operating in the network setup mode may be, for example, a user selecting a network setup mode button, or the MFP 100 being started up (turned on) for the first time. The network setup mode button may be a hard button provided in the MFP 100 or a soft button displayed on the operation display unit 220 by the MFP 100.

When starting operating in the network setup mode, the MFP 100 enables Wi-Fi® communication. Specifically, as processing performed to enable Wi-Fi® communication, the MFP 100 enables an internal AP (setup AP) of the MFP 100 that is dedicated to the network setup mode. As a result, the MFP 100 can establish a direct connection with the mobile terminal apparatus 104 via Wi-Fi®. It is assumed that connection information (a service set identifier (SSID)) or a password) used to connect to the setup AP is stored in advance in a setup application installed in the mobile terminal apparatus 104, and the mobile terminal apparatus 104 has recognized in advance the connection information used to connect to the setup AP. It is also possible that no encryption method is set in the setup AP and no password is required to connect to the AP. Therefore, it is assumed that the AP enabled in the WFD mode or the Soft AP mode is different from the setup AP. Unlike the AP connection information enabled in the direct communication mode, the connection information used to connecting to the setup AP cannot be freely changed by the user. When the MFP 100 operating in the network setup mode is connected to the mobile terminal apparatus 104, the mobile terminal apparatus 104 transmits a setting command to the MFP 100 to set the communication mode of the MFP 100, using a setup application. The setting command is, for example, a command for operating the MFP 100 in the wireless infrastructure mode described below, and more specifically, is information including connection information (SSID, password, etc.) used to connect to an AP specified by the user, such as the AP 101. A command used to operate the MFP 100 in the wireless infrastructure mode is referred to as an infrastructure setting command. When receiving an infrastructure setting command, the MFP 100 stops operation in the network setup mode, starts operation in the wireless infrastructure mode, and connects to the AP 101 using the information included in the infrastructure setting command. The MFP 100 then searches for the mobile terminal apparatus 104 on the network formed by the AP 101. That is, the MFP 100 performs a connectivity test with the mobile terminal apparatus 104 via the AP 101.

In the network setup mode, the MFP 100 may connect to the mobile terminal apparatus 104 via (WFD instead of the normal Wi-Fi®. That is, the MFP 100 may operate as a Group Owner and receive a setting command from the mobile terminal apparatus 104 through WFD communication. In addition, it is assumed that the MFP 100 operating in the network setup mode uses a predetermined communication protocol (setup communication protocol) in communication with mobile terminal apparatus 104 connected to the setup AP. Specifically, the setup communication protocol is, for example, a simple network management protocol (SNMP). Other specific examples of the setup communication protocol include hypertext transfer protocol (HTTP) and device provisioning protocol (DPP). After starting operation in the network setup mode, when a predetermined time has elapsed, the MFP 100 stops operation in the network setup mode and disables the setup AP. This is because, as described above, the setup AP is an access point that does not require a password, and if the setup AP is enabled for a long time, there is a high possibility that inappropriate apparatuses will request a connection.

### Wireless Infrastructure Mode

In the wireless infrastructure mode, communication apparatuses (for example, the mobile terminal apparatus 104 and the MFP 100) that communicate with each other are connected to an external AP (for example, the AP 101) that controls the network, and communication between the communication apparatus is performed via that AP. In other words, communication between communication apparatus is performed via a network established by an external AP. When the mobile terminal apparatus 104 and the MFP 100 each discover the AP 101 and transmit a connection request to the AP 101 to connect thereto, communication between these communication apparatuses becomes possible in the wireless infrastructure mode via the AP 101. A plurality of communication apparatuses may be connected to different APs. In this case, data transfer between the APs enables communication between the communication apparatuses. As for the commands and parameters transmitted and received during communication between communication apparatuses via an access point, it is sufficient to use those defined in the Wi-Fi® standard, and therefore the description thereof is omitted here. In addition, in the present case, the AP 101 determines the frequency band and the frequency channel. Therefore, the AP 101 can select which frequency band to use, from 5 GHz, 2.4 GHz, and 6 GHz, and which frequency channel to use within that frequency band.

### Processing Performed in Response to Request to Change Connection Destination from AP to STA

The mobile terminal apparatus 104 and the MFP 100 support the function disclosed as Wi-Fi Agile Multiband™. Wi-Fi Agile Multiband™ is a function that makes it possible to select an optimal environment based on the changing conditions of a Wi-Fi® network. Specifically, the mobile terminal apparatus 104, an STA such as the MFP 100, and an AP such as the AP 101 exchange information regarding the network environment using the IEEE 802.11 series communication standards. Via this information exchange, the AP can redirect the STA (change the connection destination) to another AP, frequency band, channel, or, for example, to another cellular service if the network is congested.

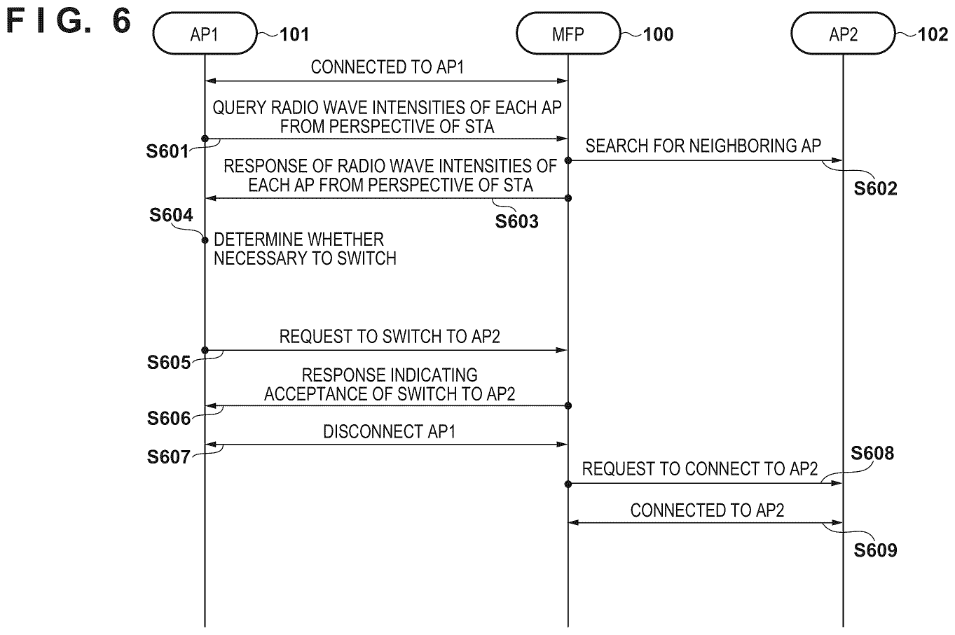

FIG. 6 is a diagram illustrating the case in which the MFP 100 switches the connection destination AP from the AP 101 to the AP 102 in response to a connection destination change request from the AP 101. The processing performed by the apparatuses in this sequence is realized by the CPU of each apparatus reading various programs stored in a memory such as a ROM of the respective apparatus into a RAM of the respective apparatus, and executing the programs.

It is assumed that, in the initial state of the processing in FIG. 6, the MFP 100 has established a connection with the AP 101 in the wireless infrastructure mode. In addition, when the MFP 100 and the AP 101 are to connect to each other in the wireless infrastructure mode, the AP 101 acquires information regarding whether the MFP 100 is compliant with IEEE 802.11v. If the AP 101 has acquired information indicating that the MFP 100 is compliant with IEEE 802.11v, the AP 101 performs the following processing.

In step S601, the AP 101 transmits to the MFP 100 an inquiry (measurement request) regarding the radio wave intensities of the APs around the MFP 100. The AP 101 transmits this inquiry, for example, as a beacon frame request or a beacon report request. That is, this request can use the mechanism defined in the IEEE 802.11k standard.

In step S602, in response to the request transmitted in step S601, the MFP 100 receives frames transmitted from the APs around the MFP 100 and measures the radio wave intensities. As a result, the radio wave intensities of the plurality of APs including the AP 101 and the AP 102 are measured.

In step S603, the MFP 100 transmits a list of the radio wave intensities of the APs around the MFP 100 measured in step S602 as a response to the request transmitted in step S601. The radio wave intensities transmitted as a response may be information stored in the RAM 214 and non-volatile memory 215 of the MFP 100 in addition to or instead of the information measured in step S602. This response is transmitted as, for example, a beacon report or a measurement report.

In step S604, the AP 101 determines, based on the congestion state in the network that the AP 101 is aware of and the radio wave intensity that the AP 101 received from the MFP 100 in step S603, whether it is necessary to switch the connection destination of the MFP 100. The factors that cause the AP 101 to determine that a connection switch is necessary include a large number of connected STAs, a large amount of communication, another AP being less congested, the presence or absence of radio interference, and the AP function being disabled. If it is determined that the connection destination of the MFP 100 needs to be switched, and the basic service set identifier (BSSID), the channel, and the frequency band of another AP to be specified as the connection destination of the MFP 100 are determined, processing proceeds to step S605. In the present embodiment, the SSID of another AP specified as the change destination of the connection destination is the same as the SSID of the AP from which the connection is changed (the BSSID differs for each AP).

In step S605, the AP 101 transmits to the MFP 100 an AP change request (a connection destination change request). The connection destination change request includes information regarding the BSSID, the channel, and the frequency band of another AP specified as the change destination for the MFP 100 determined in step S604. There may be cases where a plurality of BSSIDs are specified. In the present embodiment, the same SSID is set for APs between which the connection destination is changed using Wi-Fi Agile Multiband™, and each AP can be identified by its media access control (MAC) address BSSID. Other APs specified as candidates for the new connection destination can be identified by their MAC addresses even if they have the same SSID as the original AP. The connection destination change request is transmitted as, for example, a BTM Request. That is, the BSS transition management (BTM) Request frame defined in the IEEE 802.11v standard is transmitted. In the example in FIG. 6, it is assumed that the AP 102 is specified as the change destination included in the connection destination change request. That is, in the present embodiment, the SSID of the AP 101 and the SSID of the AP 102 are the same.

In step S606, if the MFP 100 accepts the connection destination change request received in step S605, the MFP 100 transmits a response indicating acceptance of the change to the AP 101. If the MFP 100 does not accept the connection destination change request, the MFP 100 may transmit a change denial as a response. The response is transmitted as a BTM Response. In the example in FIG. 6, it is assumed that a response indicating acceptance is transmitted.

In step S607, the AP 101 and the MFP 100 disconnects the connection in the wireless infrastructure mode.

In step S608, the MFP 100 transmits a connection request to the AP 102 to connect to the AP 102 specified in the connection destination change request received in step S605.

As a result, in step S609, a connection between the MFP 100 and the AP 102 is established in the wireless infrastructure mode.

With the above-described mechanism, the MFP 100, which is an STA, can change its connection destination from the AP 101 to the AP 102 based on a connection destination change request from the AP 101 to which the MFP 100 was originally connected. The AP 101 and the AP 102 may be APs installed in different locations. That is, the processing in FIG. 6 enables the MFP 100 to switch to another AP installed in a different position from the AP to which it was originally connected. In addition, there may be cases where the APs are compliant with different frequency bands from among a plurality of frequency bands (two or three of the 2.4 GHz, 5 GHz, and 6 GHz bands) provided by the same apparatus. That is, the processing in FIG. 6 enables the MFP 100 to switch to another frequency band provided by the same apparatus as the AP to which the MFP 100 was originally connected. For example, the connection destination can be changed to an AP that is compliant with the 6 GHz band based on a connection destination change request.

While the present embodiment describes an example in which an AP transmits a measurement request and a connection destination change request using a mechanism that conforms to Wi-Fi Agile Multiband™, and the STA responds to these requests, the present disclosure is not limited to this example. The present embodiment is also applicable in cases where a mechanism different from the above example is used so that an STA responds to or changes the connection destination AP (switches, deletes, or adds the connection destination AP) in response to a measurement request or a connection destination change request transmitted from an AP.

There are situations where changing the connection destination AP based on a request to change the connection destination AP transmitted from the currently connected AP is acceptable and situations where it is not desirable. In situations where it is not desirable to change the connection destination AP based on a change request, one or a combination of the following processes can be performed as processes for suppressing the change of the connection destination in response to the change request. The following processes are those that either prevent a change in the connection destination AP or make such a change less likely to occur based on a change request.

### Suppression Process 1

Even if the change request described for step S605 is received, the connection destination AP is not changed based on the received connection request, and a response to the change request is not returned, or a response to the change request denying the change request (indicating that the connection destination AP will not be changed) is transmitted to the currently connected AP.

If a denial response is transmitted, the priority of changing the connection destination of other STAs connected to the AP to which the MFP 100 is currently connected is increased, and the priority of changing the connection destination of the MFP 100, which returned the denial response, is decreased, resulting in the MFP 100 being able to maintain its connection to the AP to which it is currently connected. In addition, when no response is returned (when the request is ignored), the currently connected AP is considered to maintain the connection to the MFP 100 to wait for a response until the response waiting time times out. Therefore, in a situation where the connection is to be immediately terminated based on a response to a change request from the MFP 100, the time that the connection can be maintained with the currently connected AP can be increased by not responding to the request rather than returning a response. Therefore, based on the information regarding the reason for the change contained in the change request, a different process can be performed depending on the reason. For example, if the reason is weak, a denial is returned, and if the reason is strong, the request is ignored. The reason for the change can be determined based on information contained in the Request Mode included in the BTM Request, which indicates, for example, which of several reasons applies. For example, if the Disassociation Imminent bit or the BSS Termination Included bit of the Request Mode is 1, it can be determined that the change request has a strong reason for the change. Otherwise, it can be determined that the change request has a weak reason.

### Suppression Process 2

In response to the measurement request described in step S601, the AP responds with information indicating that the radio wave reception conditions (signal reception conditions) of non-connected APs other than the connected AP are lower (lower signal quality) than the reception conditions actually measured (a false response). In this case, a response may be made by actually performing a measurement in response to the reception of a measurement request or a response may be made without actually performing a measurement. Specifically, in the response (beacon report, etc.) described in step S603, the signal quality measured as the signal received from the non-connected AP is responded to with a value with the received signal intensity reduced and/or with a value with the noise increased (signal-to-noise ratio reduced). The response may not include at least one type of information regarding the non-connected APs. In addition, based on information previously measured for the non-connected APs, the response may be made with a significantly reduced received signal intensity or with a significantly increased noise value. Even if a measurement request is received, the response may be made without actually performing a measurement (performing an AP search) and without including information regarding non-connected APs, indicating that the received signal intensity and noise conditions are favorable only with respect to the connected AP. A response to a measurement request that does not include information regarding non-connected APs is equivalent to an AP search not finding other non-connected APs. That is, a response that does not include information regarding the non-connected APs indicates that at least some of the signal qualities from the non-connected APs are lower than in the case of an actual AP search. As a result, a request to change the connection destination from the currently connected AP to another AP is expected to be suppressed. Therefore, the connection destination is prevented from being changed in response to a connection destination change request.

### Suppression Process 3

The currently connected AP is temporarily disconnected, a notification indicating that a change request is not supported is issued, and the connection to the same AP is established again. Specifically, the wireless connection with the currently connected AP is temporarily disconnected, and then in preparation for reconnecting to the AP wirelessly, Association Request frame data is created that contains information indicating that the AP is not compliant with IEEE 802.11v. The data in the created Association Request frame is then used to perform connection processing with the AP. As a result, if an Association Request frame is created that contains information indicating that the apparatus is not compliant with IEEE 802.11v, the apparatus will be connected to the AP as an electronic apparatus that is not compliant with the Agile Multiband function. As a result, the currently connected AP recognizes that the MFP 100 is not compliant with IEEE 802.11v, and will not transmit a request to change the wireless connection destination to the MFP 100. Thus, a request to change the wireless connection will not be made to the MFP 100, and the wireless connection between the MFP 100 and the currently connected AP will be more likely to be maintained. In addition, if the connected AP recognizes that the MFP 100 is not compliant with IEEE 802.11v, the transmission of a measurement request (the request described in step S601) from the connected AP to the MFP 100 is also suppressed. Therefore, it is also possible to suppress the measurement (AP search) by the MFP 100 in response to the measurement request and the response to the measurement request (the processing in step S603). As a result, the processing load and power consumption can be reduced and resources can be allocated to other processes.

An example of a situation in which it is not desirable to change the connection destination AP based on a change request is when print data is being received. While the MFP 100 is receiving print data, part of the print data of the image to be printed has already been received from the mobile terminal apparatus 104, which is the other apparatus, and reception of the remaining part of the print data has not been completed. The MFP 100 does not store all the print data to be printed on one sheet of paper. Therefore, when the MFP 100 receives a piece of print data, the MFP 100 prints only the received piece (for example, receives and prints one line), and when the MFP 100 receives the subsequent piece of data, the MFP 100 prints that piece, etc. If the connection destination AP is changed based on a connection destination change request while the MFP 100 is receiving this print data, a time lag occurs due to the connection destination switching processing, which may result in a decrease in print quality, such as uneven printing. In addition, after changing the connection destination, communication with the mobile terminal apparatus 104, which is the other apparatus, may not work well, and subsequent data may not be received, resulting in a printing failure. Therefore, while receiving print data, at least one of the above-described “Suppression Process 1” and “Suppression Process 2” is performed to suppress a connection destination change in response to a change request, or the above-described “Suppression Process 3” is performed before starting to receive print data.

As described above, when the MFP 100 receives a connection destination change request from the currently connected AP, if it is not desirable to change the connection destination AP based on the change request, the MFP 100 performs the above-described Suppression Process 1 or the like to maintain the connection with the currently connected AP. Even if Suppression Process 1 is performed by the MFP 100, there is a possibility that the connection may be terminated from the currently connected AP. If the MFP 100 is disconnected from the currently connected AP, it may enter a state where it is not connected to the network. In a state where the MFP 100 is not connected to the network, for example, the MFP 100 cannot execute a function that uses the network (for example, receiving print data from the mobile terminal apparatus 104 or an external server via the AP). Therefore, when the MFP 100 is disconnected from the currently connected AP, there is a need to appropriately perform control for reconnecting to the network.

Therefore, in the present embodiment, the MFP 100 receives a connection destination change request from a first access point to which the MFP 100 is currently connected. When the MFP 100 receives a change request, the MFP 100 stores information regarding a second access point that is the connection change destination recommended in the change request, and performs control to not change the connection destination based on the change request. After performing control to not change the connection destination based on a change request, when the MFP 100 is disconnected from the currently connected first access point, the MFP 100 performs control to connect to the second access point based on the stored information regarding the second access point. Alternatively, when the MFP 100 is disconnected from the currently connected first access point, the MFP 100 reconnects to the first AP if the conditions for reconnecting to the first AP are satisfied. Thus, even if the MFP 100 is disconnected from the currently connected AP, the MFP 100 can appropriately perform control to reconnect to the network when the MFP 100 is disconnected from the AP.

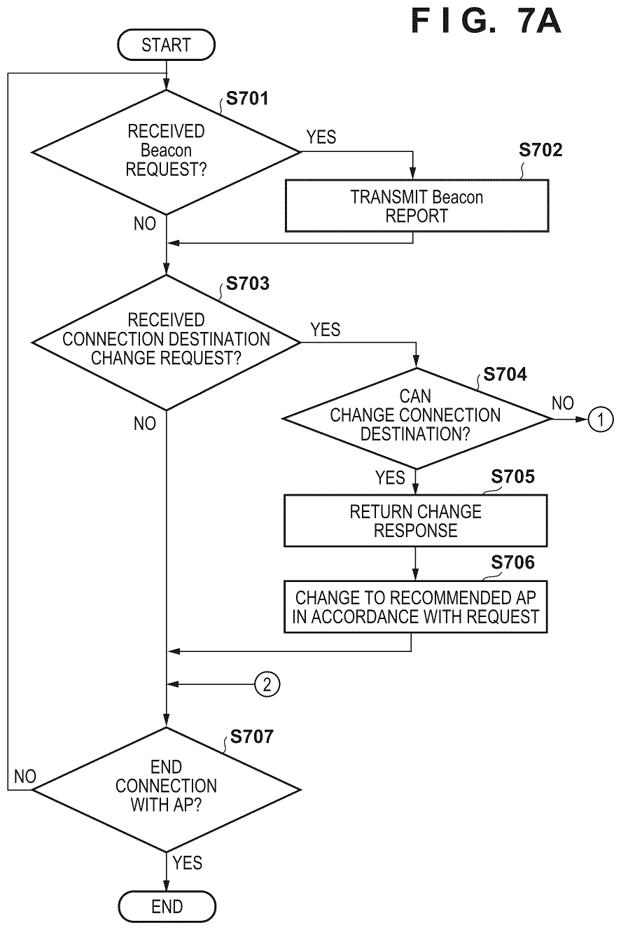

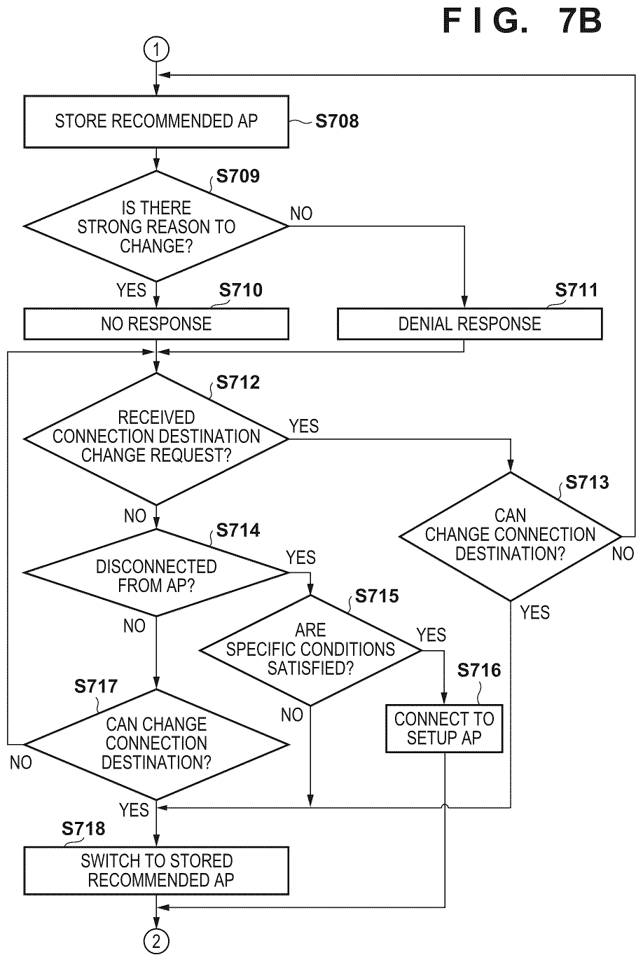

Next, the control performed by the MFP 100 in response to a connection destination change request from the AP 101 will be described with reference to the flowchart in FIGS. 7A and 7B. The processing in FIGS. 7A and 7B are realized, for example, by the CPU 212 reading out a program stored in the ROM 213, which is a computer-readable recording medium, into the RAM 214 and executing the program.

It is assumed that, in the initial state of the processing in FIGS. 7A and 7B, the MFP 100 has established a connection with the AP 101 in the wireless infrastructure mode. When the MFP 100 and the AP 101 attempt to connect to each other in the wireless infrastructure mode, the AP 101 acquires information regarding whether the MFP 100 is compliant with IEEE 802.11v. If information indicating that the MFP 100 is compliant with IEEE 802.11v has been acquired, the following processing is performed.

In the present embodiment, the same SSID is set in the AP 101 and the AP 102 before the processing in FIGS. 7A and 7B is started. For example, since the AP 101 and the AP 102 are APs that support the Wi-Fi Agile Multiband™ function, the same SSID is set for the AP 101 and an AP (e.g., AP 102) to which the user can change the connection destination.

In step S701, the MFP 100 determines whether an inquiry (measurement request) regarding the radio wave intensities of the APs around the MFP 100 has been received from the AP 101. This inquiry can include a beacon frame request or a beacon report request, and in the present embodiment, it is assumed that the inquiry includes either of these requests. The inquiry whether the MFP 100 has received the radio wave intensities in step S701 corresponds to the inquiry transmitted by the AP 101 in step S601 in FIG. 6. If the MFP 100 determines in step S701 that the inquiry has been received, processing proceeds to step S702. If the MFP 100 determines that the inquiry has not been received, processing proceeds to step S703.

In step S702, as described for steps S602 and S603 in FIG. 6, the MFP 100 measures the radio wave intensities of the APs around the MFP 100 (AP search), and transmits a list of the radio wave intensities of the APs to the AP 101 as a Beacon report. Specifically, the MFP 100 starts searching for APs by transmitting a device search request (Probe Request).

The MFP 100 then searches for and finds APs by receiving wireless signals transmitted from the APs, such as a device search response (Probe Response) and Beacons (information that the APs voluntarily transmit periodically). AP information acquired from an AP by such an AP search includes information indicating at least one of the SSID, radio wave intensity, frequency band, MAC address, authentication method, encryption method, etc. of the AP. The content of the AP information varies depending on the AP model, model number, settings, etc. The MFP 100 transmits to the AP 101 a list of the radio wave intensities of the APs acquired by the AP search.

In step S703, the MFP 100 determines whether a connection destination change request transmitted by the AP 101 has been received. If the MFP 100 determines that the signal has been received, processing proceeds to step S704. If the MFP 100 determines that the signal has not been received, processing proceeds to step S707. In this processing, the connection destination change request for which it is determined whether it has been received by the MFP 100 corresponds to the AP change request (connection destination change request) transmitted by the AP 101 in step S605 in FIG. 6.

In step S704, the MFP 100 determines whether the connection destination AP can be changed. If the MFP 100 determines that the connection destination AP can be changed, processing proceeds to step S705. If the MFP 100 determined that the connection destination AP cannot be changed, processing proceeds to step S708. Whether the connection destination AP can be changed is determined based on, for example, whether the MFP 100 is communicating with an external server via the AP 101. For example, when the MFP 100 is communicating with an external server, if the connection to the AP 101 is immediately disconnected, the communication is forcibly interrupted without termination processing, and the reconnection procedure may take a long time. Thus, in step S704, if the MFP 100 is communicating with an external server via the AP 101, the MFP 100 determines that the connection destination cannot be changed. That is, in this processing, the MFP 100 determines whether the MFP 100 is in a state in which the connection destination can be changed or in a state in which the connection destination cannot be changed.

In step S705, the MFP 100 transmits a response to the AP 101 indicating that the MFP 100 accepts the received connection destination change request. The processing in step S705 corresponds to the processing in step S606 in FIG. 6. In step S706, the MFP 100 disconnects from the AP 101, and performs connection processing with the recommended AP included in the connection destination change request. The processing in step S706 corresponds to the processing in steps S607 and S608. The recommended AP is an AP that is recommended as a connection destination by the currently connected AP, and corresponds to the AP specified (determined) as a change destination by the AP 101 in step S604.

In step S707, the MFP 100 determines whether to terminate the connection with the currently connected AP 101. If the MFP 100 determines that the connection should be terminated, processing proceeds to step S701. If the MFP 100 determines that the connection should not be terminated, the processing in FIGS. 7 and 7B is terminated. For example, when the MFP 100 receives an instruction to turn off the MFP 100 (for example, selecting a power button (not illustrated) of the MFP 100), the MFP 100 determines to terminate the connection with the AP 101. When the MFP 100, for example, receives an instruction to disable the Wi-Fi® setting from a Wi-Fi® setting screen on the operation display unit 220 of the MFP 100, the MFP 100 determines to terminate the connection with the AP 101.

In step S708, the MFP 100 stores the information regarding the recommended AP included in the received connection destination change request in the RAM 214, and processing proceeds to step S709. The information regarding the recommended AP that the MFP 100 stores in the RAM 214 includes, for example, the BSSID (MAC address), channel, and frequency band information regarding the recommended AP.

In step S709, the MFP 100 references the reason for the change included in the received request to change the connection destination, and determines whether the reason for the change is a strong reason. If the MFP 100 determines that the reason for the change is a strong reason, processing proceeds to step S710. If the MFP 100 determines that the reason for the change is not a strong reason, processing proceeds to step S711. For example, the MFP 100 determines that the reason for the change is a strong reason if the Disassociation Imminent bit or the BSS Termination Included bit in the Request Mode of the BTM Request is 1.

In step S710, the MFP 100 does not return a response to the connection destination change request, and processing proceeds to step S712. Since the connection destination change request includes a strong reason for the change, even if the MFP 100 transmits a change denial response to the AP 101, the AP 101 may forcibly disconnect the connection with the MFP 100 upon receiving the response. If there is a strong reason for the change, it is expected that the connection will be maintained until the timeout occurs while waiting for a response from the AP 101. Thus, in step S710, the MFP 100 does not return a change denial response.

In step S711, the MFP 100 transmits a response to the AP 101 indicating that the connection destination change request is denied, and processing proceeds to step S712. Since there is no strong reason for the connection destination change request, even if the MFP 100 transmits a change denial response to the AP 101, the AP 101 will not receive the response and will not forcibly disconnect the AP 101. Thus, when there is no strong reason for the change, it is expected that the AP 101 will maintain the connection without forcibly disconnecting the connection. In step S711, the MFP 100 transmits a response indicating that the change of the connection destination is denied. This processing corresponds to the processing performed to transmit a response denying the change when the connection destination change request is not accepted in step S606 in FIG. 6. The processing in steps S710 and S711 corresponds to the Suppression Process 1 described above.

In step S712, the MFP 100 determines whether a connection destination AP change request has been received again from the AP 101. If the MFP 100 determines that the connection destination change request has been received, processing proceeds to step S713. If the MFP 100 determines that the connection destination change request has not been received, processing proceeds to step S714.

In step S713, the MFP 100 determines whether the connection destination AP can be changed. If the MFP 100 determines that the connection destination AP can be changed, processing proceeds to step S718. If the MFP 100 determines that the connection destination AP cannot be changed, processing proceeds to step S708 and overwrites the RAM 214 with the information regarding the recommended AP that is included in the change request that is received again.

In step S714, the MFP 100 determines whether the MFP 100 has been disconnected from the AP 101. For example, after the MFP 100 performs the processing in step S710 or the processing in step S711, the AP 101 may forcibly disconnect the communication connection with the MFP 100. If the MFP 100 determines that the MFP 100 has been disconnected, processing proceeds to step S715. If the MFP 100 determines that the MFP 100 has not been disconnected, processing proceeds to step S717. In step S714, for example, when the MFP 100 receives a notification from the AP 101 indicating that the connection with the MFP 100 is to be disconnected, the MFP 100 determines that the connection with the AP 101 has been disconnected.

In step S715, the MFP 100 determines whether specific conditions are satisfied. If the MFP 100 determines that the specific conditions are satisfied, processing proceeds to step S716. If the MFP 100 determines that the specific conditions are not satisfied, processing proceeds to step S718.

The specific conditions include, for example, a condition that, after the MFP 100 is disconnected from the AP 101, the MFP 100 performs an AP search to check the radio wave intensity of the AP 101 and the radio wave intensity of the AP 101 is higher than a predetermined condition (a threshold value that vary depending on condition, a predetermined value, etc.). That is, the specific conditions include a condition that the radio wave intensity of the AP 101 is favorable. The AP search that the MFP 100 performs after the connection with the AP 101 is disconnected is the same as the AP search described for step S702, and therefore the description thereof will be omitted.

The specific conditions also include, for example, a condition that the MFP 100 performs an AP search to check the radio wave intensity of the AP 101 after being disconnected from the AP 101 and the radio wave intensity of the AP 101 is lower than a predetermined condition (a threshold value that vary depending on condition, a predetermined value, etc.). That is, the specific conditions include a condition that the radio wave intensity of the recommended change AP is not favorable.

The specific condition may include, for example, a condition that after being disconnected from the AP 101, the MFP 100 performs an AP search with respect to the radio wave intensity of the AP 101 and the radio wave intensity of the recommended AP, and compares the search results to find that the radio wave intensity of the recommended AP is lower than the radio wave intensity of the AP 101.

The specific conditions also include a condition that the MFP 100 is disconnected from the AP 101 while performing a connectivity test with the mobile terminal apparatus 104 via the AP 101. Specifically, for example, as described above, the MFP 100 may operate in the network setup mode and establish a direct connection with the mobile terminal apparatus 104. Then, when receiving an infrastructure setting command from the mobile terminal apparatus 104, the MFP 100 stops operation in the network setup mode, starts operation in the wireless infrastructure mode, and connects to the AP 101 using the information included in the infrastructure setting command. Thereafter, the MFP 100 performs a connectivity test with the mobile terminal apparatus 104 via the AP 101, but the MFP 100 may be disconnected from the AP 101 during the connectivity test. In such a case, if the MFP 100 changes the connection destination to the recommended AP, since the connectivity test via the AP 101 cannot be performed. Thus, if the MFP 100 is disconnected from the AP 101 during the connectivity test with the mobile terminal apparatus 104 via the AP 101, this condition is included as a specific condition in order to return the connection destination to the AP 101.

The specific conditions also include, for example, a condition that the MFP 100 is not in a power saving state. A case where the MFP 100 is not in a power saving state means that the MFP 100 is running in a normal power state. For example, when the MFP 100 is operating in a normal power state, the MFP 100 may be disconnected from the AP 101 while the MFP 100 is receiving print data or performing predetermined processing, such as print processing based on print data. This condition is included in the specific conditions so that, when the MFP 100 is not in a power saving state, the MFP 100 reconnects to the AP 101, which is the originally connected AP and continues the above-described predetermined processing or performs processing to properly terminate the predetermined processing.

The power saving state is, for example, a state in which power consumption is lower than that in the normal operating state. Specifically, the power saving state may be, for example, a sleep mode. For example, when the MFP 100 is in the sleep mode, the power supply to the backlight of the operation display unit 220 may be stopped. The MFP 100 may, for example, transition from the normal power state to the power saving state when no operation or predetermined processing is accepted on the operation display unit 220 for a certain period of time, or when a power saving key (not illustrated) is detected to have been selected. In other words, when the MFP 100 is in the power saving state, it can be considered that the MFP 100 is not performing the above-described predetermined processing, and that the user is not using the MFP 100. When the specific conditions are not satisfied (the MFP 100 is in a power saving state), it is determined that there is no problem in changing the connection destination AP and the MFP 100 performs control to change the connection destination to the recommended AP, as described below.

In step S716, the MFP 100 reconnects to the AP 101. The MFP 100 uses connection information such as the MAC address of the AP 101 to reconnect to the AP 101. It is assumed that MFP 100, for example, stores connection information regarding the AP 101 in a memory such as the RAM 214.

After the MFP 100 performs control to connect to the AP 101 in step S716, if the MFP 100 receives a connection destination change request from the AP 101 again and the connection to the AP 101 is disconnected again, the determination in step S715 may not be performed and processing may proceed to step S708. If the MFP 100 reconnects to the AP 101 in step S716, but the MFP 100 is disconnected again, there is a possibility that the MFP 100 will be disconnected from the AP 101 even if the MFP 100 repeatedly attempts to connect to the AP 101. In such a case, the MFP 100 proceeds to step S718 and performs control to connect to the recommended AP.

While the present embodiment describes an example in which control is performed in step S716 to reconnect to the AP 101, the present disclosure is not limited to this example. For example, in step S716, the MFP 100 may store in the RAM 214 the history and connection information (such as the MAC addresses) of APs to which the MFP 100 has previously connected, and connect to the AP.

In step S717, the MFP 100 determines whether the MFP 100 is in a state where the MFP 100 can change the connection destination AP. If the MFP 100 determines that the MFP 100 is in a state where the MFP 100 can change the connection destination AP, processing proceeds to step S718. If the MFP 100 determines that the MFP 100 is in a state where the MFP 100 cannot change the connection destination AP, processing proceeds to step S712. This determination is performed in the same way as in steps S704 and S713, and therefore a detailed description thereof will be omitted.

In step S718, the MFP 100 performs control to change the connection destination AP to the recommended AP using the information regarding the recommended AP stored in step S708. That is, the MFP 100 performs control to connect to the recommended AP. The processing to change the connection destination AP is performed in the same way as in steps S607, S608, and S609 in FIG. 6.

In the present embodiment, the MFP 100 performs the processing in step S718 and then proceeds to step S707, but the present disclosure is not limited to this example. For example, if predetermined processing is interrupted due to a loss of connection with the AP 101, the MFP 100 may perform control in step S718 to connect to the recommended change AP, and then perform control to perform the interrupted predetermined processing. The predetermined processing may be, for example, receiving print data or performing printing based on print data.

As described above, according to the present embodiment, when the MFP 100 receives a connection destination change request from the currently connected AP 101, the MFP 100 stores information regarding the recommended AP included in the change request and performs control to not change the connection destination. After performing control not to change the connection destination, when the MFP 100 is disconnected from the currently connected AP 101, the MFP 100 performs control to change the connection destination AP to the recommended AP by using the stored information regarding the recommended AP. When the specific conditions are satisfied, the MFP 100 performs control to reconnect to the originally connected AP. Thus, the MFP 100 can appropriately perform control to connect to the network even if the MFP 100 is disconnected from the currently connected AP.

The various above-described control is carried out by the CPU 212. In another embodiment, the control may be performed by a single hardware element, or a plurality of hardware elements (e.g., a plurality of processors or circuits) may share the processing to perform the control.

While the above-described embodiment discusses an example referencing an MFP, this is not seen to be limiting. The present disclosure is applicable to any wireless apparatus that functions as a STA that can process a connection destination change request from an AP. That is, the present disclosure is applicable to various measuring apparatuses (sensor apparatuses) such as personal computers, PDAs, tablet terminals, mobile phone terminals such as smartphones, music players, game consoles, e-book readers, smart watches, thermometers, and hygrometers. The present disclosure is also applicable to digital cameras (including still cameras, video cameras, network cameras, and security cameras), printers, scanners, and drones. The present disclosure is also applicable to video output apparatuses, audio output apparatuses (e.g., smart speakers), media streaming players, and wireless LAN client apparatuses (adapters) that can be connected to USB terminals or LAN cable terminals. Examples of video output apparatuses include apparatuses such as a set-top box, which acquires (downloads) videos and still images on the Internet identified by URLs specified by an electronic apparatus, and outputs them to a connected display apparatus via a video output terminal such as HDMI (registered trademark). As a result, streaming playback on a display apparatus and mirroring display (the content displayed on an electronic apparatus is also displayed on a display apparatus) are realized. The video output apparatuses include a media player such as a television, a hard disk recorder, a Blu-ray recorder, and a DVD recorder, a head-mounted display, a projector, a television, a display apparatus (monitor), a signage apparatus, and so on. The present disclosure is also applicable to smart devices, such as smart home appliances like air conditioners, refrigerators, washing machines, vacuum cleaners, ovens, microwave ovens, lighting appliances, heating appliances, and cooling appliances, which are capable of connecting to Wi-Fi®.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-023948, filed Feb. 20, 2024, which is hereby incorporated by reference herein in its entirety.

What is claimed is:

1. An electronic apparatus, comprising:
a communication device unit configured to receive, from a first access point to which the electronic apparatus is currently connected, a change request of an access point serving as a connection destination; and
at least one memory storing a program and at least one processor that when executing the program is configured to:
store, after receipt of the change request, information regarding a second access point that is a connection change destination recommended in the change request,
perform control to not change the connection destination based on the received change request, and
perform control, when the electronic apparatus is disconnected from the currently connected first access point, to connect to the second access point based on the stored information.

2. The electronic apparatus according to claim 1,
wherein the at least one processor is further configured to, when the electronic apparatus is disconnected from the currently connected first access point and one or more specific conditions are satisfied, perform control to connect to the first access point regardless of the stored information.

3. The electronic apparatus according to claim 2,
wherein the one or more specific conditions include a condition that after being disconnected from the first access point, the electronic apparatus searches for a radio wave intensity of the first access point, wherein the radio wave intensity of the first access point is higher than a predetermined condition.

4. The electronic apparatus according to claim 2,
wherein the one or more specific conditions include a condition that after being disconnected from the first access point, the electronic apparatus searches for a radio wave intensity of the second access point, wherein the radio wave intensity of the second access point is lower than a predetermined condition.

5. The electronic apparatus according to claim 2,
wherein the one or more specific conditions include a condition that the electronic apparatus is disconnected from the first access point while performing a connectivity test with an external apparatus via the first access point.

6. The electronic apparatus according to claim 2,
wherein the one or more specific conditions include a condition that the electronic apparatus is not in a power saving state.

7. The electronic apparatus according to claim 1,
wherein the at least one processor is further configured to:
store the information, and perform control to, when the electronic apparatus is disconnected from the currently connected first access point, connect to the second access point based on the stored information.

8. The electronic apparatus according to claim 1,
wherein the at least one processor is further configured to:
determine whether the electronic apparatus is in a state of being able to change a connection destination access point based on the received change request, and
perform control to, when the change request is received and the electronic apparatus is in a state of being unable to change the connection destination access point based on the received change request, store information regarding the second access point that is the connection change destination recommended in the change request, and
perform control to not change the connection destination based on the change request.

9. The electronic apparatus according to claim 1,
wherein the at least one processor is further configured to, when any processing has been interrupted due to disconnection from the first access point, perform control to connect to the second access point based on the stored information and then perform the interrupted processing.

10. The electronic apparatus according to claim 1,
wherein the electronic apparatus connects to access points and performs processing conforming to an IEEE 802.11ax standard.

11. The electronic apparatus according to claim 1,
wherein the electronic apparatus performs at least one processing conforming to orthogonal frequency-division multiple access (OFDMA) or to target wake time (TWT).

12. The electronic apparatus according to claim 1,
wherein the electronic apparatus changes the connection destination to a 6 GHz band access point by changing the connection destination based on the received change request.

13. The electronic apparatus according to claim 1, further comprising
a printer that performs print processing based on print data received via an access point to which the electronic apparatus is currently connected.

14. A method for controlling an electronic apparatus, the method comprising:
receiving, from a first access point to which the electronic apparatus is currently connected, a change request of an access point serving as a connection destination;
storing, after receipt of the change request, information regarding a second access point that is a connection change destination recommended in the change request;
performing control to not change the connection destination based on the received change request; and
performing control, when the electronic apparatus is disconnected from the currently connected first access point, to connect to the second access point based on the stored information.

15. A non-transitory computer-readable storage medium storing a program that causes an electronic apparatus to execute a method, the method comprising:
receiving, from a first access point to which the computer is currently connected, a change request of an access point serving as a connection destination;
storing, after receipt of the change request, information regarding a second access point that is a connection change destination recommended in the change request;
performing control to not change the connection destination based on the received change request; and
performing control, when the electronic apparatus is disconnected from the currently connected first access point, to connect to the second access point based on the stored information.
